(19) United States
(12) Patent Application Publication
(10) Pub. No.: US 2018/0008947 A1
(43) Pub. Date: Jan. 11, 2018

(54) CATALYTIC REACTION ANALYSIS DUAL REACTOR SYSTEM AND A CALIBRATION METHOD FOR CORRECTING NON-CATALYTIC EFFECTS USING THE DUAL REACTOR SYSTEM

(71) Applicant: SABIC Global Technologies B.V., Bergen op Zoom (NL)

(72) Inventors: YongMan Choi, Riyadh (SA); Ramsey Bunama, Riyadh (SA); Khalid M. El-Yahyaoui, Riyadh (SA)

(21) Appl. No.: 15/548,278

(22) PCT Filed: Feb. 1, 2016
(86) PCT No.: PCT/IB2016/050503

§ 371 Date: Aug. 2, 2017

Related U.S. Application Data
(60) Provisional application No. 62/111,467, filed on Feb. 3, 2015.

(51) Int. Cl. B01J 8/00; B01J 19/00; B01J 19/24; G01N 31/10; C10G 29/00; B01J 8/02; C10G 11/10

(52) U.S. Cl. CPC B01J 8/001; B01J 8/0285; B01J 19/0013; C10G 11/10; G01N 31/10; B01J 8/0278; C10G 29/00; B01J 19/2445; B01J 2208/00504; B01J 2219/00157; B01J 2208/021

(57) ABSTRACT

A catalytic reaction analysis dual reactor system and a method for measuring the catalytic activity of a catalyst by correcting for non-catalytic effects with the catalytic reaction analysis dual reactor system. The dual reactor system contains a first reactor comprising a first catalyst on a first catalyst support, and a second reactor comprising a second catalyst support, wherein the particle size and amount of the first catalyst and the second catalyst support are substantially the same, and the effect of the catalyst is isolated by correcting the result obtained from the first reactor containing the catalyst with the result obtained from the second reactor containing the catalyst support.

### TECHNICAL FIELD

The present disclosure relates to a catalytic reaction analysis dual reactor system and a calibration method for correcting non-catalytic effects in hydrocarbon cracking processes using the dual reactor system.

### BACKGROUND

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present disclosure.

Light olefins and light hydrocarbons can be produced from natural gases, such as ethane, propane, or isobutane, through various processes, including catalytic conversion or thermal cracking processes. Light olefins, such as ethylene and/or propylene, are particularly desirable olefin products because they are useful for making plastics and synthetic rubbers. For example, ethylene can be used to make various polyethylene plastics, and other bulk chemicals such as vinyl chloride, ethylene oxide, ethylbenzene and ethanol. Similarly, propylene can be used to make various polypropylene plastics and other bulk chemicals such as acrylonitrile and propylene oxide. As economies around the world continue to trend toward growth and expansion, the demand for light olefins will increase dramatically.

Determination of conversion, selectivity and yield are essential reaction parameters for monitoring and optimizing catalytic dehydrogenation and cracking reactions. To accurately measure the conversion, selectivity, and yield for catalytic reactions, a calibration is essential. In general, calibration processes are performed at ambient temperature, while catalytic experiments in heterogeneous catalysis are commonly carried out at high temperatures. In such a scenario, experimental errors resulting from an inaccurate feed concentration, gas pressure drop, etc., are unavoidable.

In addition to experimental errors stemming from the temperature discrepancy between a reaction and a calibration process, catalytic experiments carried out at high temperatures to activate catalysts give rise to inherent measurement errors in the form of inevitable side reactions (i.e., thermal cracking of hydrocarbons). Thus, in addition to measuring catalyst activity, a reaction that requires high temperatures will inevitably also measure thermal reactivity, or “non-catalytic” reactivity. Any catalytic reactivity analysis that does not correct for the inherent “background” thermal reactivity will result in inaccurate catalysis measurements.

Table 1 shows the product ratio from the pure thermal cracking of isobutane at 600° C. and at 1 atm with GHSV=0.1 h⁻¹. The measured conversion of isobutane is 6.4% and the products are varied from C1 to C4 species. Table 1 suggests that even in the absence of a catalyst, thermal cracking of isobutene at high temperatures is unavoidable, and results in a wide mixture of products. Furthermore, in the dehydrogenation reaction of alkanes, higher reaction temperature results in higher alkane conversions. It can therefore be expected, that as reaction temperatures are increased in order to increase conversion and yield, thermally-promoted cracking will also increase. Reaction temperature and “background” reactivity must therefore be taken into account for accurate catalytic reaction analysis.

TABLE 1
Summary of product gases from the thermal cracking of isobutane

| Products | Selectivity(%) |
|---|---|
| CH₄ | 46.7 |
| C₂H₄ | 3 |
| C₂H₆ | 6.2 |
| C₃H₆ | 38.1 |
| C₃H₈ | 0.6 |
| i-C₄H₈ | 5.4 |

Several different strategies have been reported for isolating catalytic effects of catalytic systems. Pinto, F. et al. (Fuel 2011, 90, pp. 1645-1654—incorporated herein by reference in its entirety) disclosed a system for testing a reaction in the presence of a catalyst followed by testing in the absence of the catalyst.

Petrov, L. (Principles and Methods for Accelerated Catalyst Design and Testing, NATO Science Series, “Problems and Challenges About Accelerated Testing of the Catalytic Activity of Catalysts” 2002, Vol 69, pp. 13-69—incorporated herein by reference in its entirety) discloses the concept of parallel multichannel reactors for testing large libraries of catalysts under steady state conditions. Furthermore, Luyben, W. (Wiley, “Chemical Reactor Design and Control” 2007, pp. 319—incorporated herein by reference in its entirety) discloses the use of parallel reactors utilizing several catalytic beds concurrently in parallel. None of these references disclose a dual reactor system including an inert reactor bed and an active reactor bed composed of the same material except for the presence or absence of a catalyst, arranged in parallel in order to obtain normalized calibration data at the operating conditions of the active bed to determine the activity of the catalyst therein.

In view of the forgoing, one aspect of the present disclosure is to provide a dual reactor system with a catalytic and a “non-catalytic” reactor, and a method for correcting non-catalytic effects using the dual reactor system to minimize experimental error in hydrocarbon cracking reactions.

### BRIEF SUMMARY

According to a first aspect, the present disclosure relates to a catalytic reaction analysis dual reactor system. The dual reactor system includes a gas loop comprising an inert gas source, a feed gas source, a gas feed line, a first reactor feed line and second reactor feed line, wherein the inert gas source and the feed gas source are in fluid communication with the gas feed line and the gas feed line is in fluid communication with the first and second reactor feed lines; a first reactor comprising a first catalyst chamber loaded with a catalyst comprising a first catalyst on a first catalyst support, a first reactor inlet on an upstream side of the first catalyst chamber and a first reactor outlet on a downstream side of the first catalyst chamber; a second reactor comprising a second catalyst chamber loaded with a second catalyst support, a second reactor inlet on an upstream side of the second catalyst chamber and a second reactor outlet on a downstream side of the second catalyst chamber, wherein the first and second catalyst chambers are substantially the same and the particle size and amount of the first catalyst and the second catalyst support are substantially the same; and a gas analyzer comprising an analysis feed line downstream of and connected to the first and second reactor outlets, wherein the first and second reactor are connected in parallel to the gas feed line and the analysis feed line.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is an illustration of the dual reactor system.

FIG. 2 is a general depiction of the PC control unit.

### DETAILED DESCRIPTION

Disclosed herein is a catalytic reaction analysis dual reactor system. The dual reactor system can include a gas loop comprising an inert gas source, a feed gas source, a gas feed line, a first reactor feed line and second reactor feed line, wherein the inert gas source and the feed gas source can be in fluid communication with the gas feed line. The gas feed line can be in fluid communication with the first and second reactor feed lines. The dual reactor system can include a first reactor comprising a first catalyst chamber loaded with a catalyst comprising a first catalyst on a first catalyst support, a first reactor inlet on an upstream side of the first catalyst chamber and a first reactor outlet on a downstream side of the first catalyst chamber. The dual reactor system can include a second catalyst chamber loaded with a second catalyst support, a second reactor inlet on an upstream side of the second catalyst chamber and a second reactor outlet on a downstream side of the second catalyst chamber. The first and second catalyst chambers can be substantially the same and the particle size and amount of the first catalyst and the second catalyst support can be substantially the same. The dual reactor system can include a gas analyzer comprising an analysis feed line downstream of and connected to the first and second reactor outlets. The first and second reactors can be connected in parallel to the gas feed line and the analysis feed line.

In one embodiment, the gas loop can comprise two three way valves positioned in the gas feed line between the first reactor feed line and the second reactor feed line, wherein the feed gas and the inert gas source are shared and the three way valves may be adjusted so that i) the feed gas is passed through the second reactor while the inert gas is passed through the first reactor, or ii) the feed gas is passed through the first reactor while the inert gas is passed through the second reactor.

In one embodiment, the catalytic reaction analysis dual reactor system can further comprise a first inlet pressure sensor located upstream of and connected to the gas feed line of the first reactor and a second inlet pressure sensor located upstream of and connected to the gas feed line of the second reactor, and a first outlet pressure sensor located downstream of and connected to the first reactor outlet and a second outlet pressure sensor located downstream of and connected to the second reactor outlet. In such an embodiment, the first and second inlet pressure sensors measure the pressure of gas entering the first and second reactors, and the first and second outlet pressure sensors measure the pressure of gas exiting the first and second reactors in parallel.

In one embodiment, the catalytic reaction analysis dual reactor system can further comprise a tube furnace, and a PC control unit, wherein the PC control unit can control the temperature of the tube furnace and the tube furnace can control the temperature of the first and second reactor. The temperature of the first and second reactor can be the same throughout the catalytic reaction analysis.

In one embodiment, the feed gas can be a hydrocarbon gas, and the catalytic reaction can be a hydrocarbon cracking reaction.

In one embodiment, the feed gas can be a hydrocarbon gas, and the catalytic reaction can be a hydrocarbon dehydrogenation reaction.

In one embodiment, the first and the second reactors can be fixed-bed reactors.

Also disclosed herein is a method for measuring the catalytic activity of a catalyst by correcting for non-catalytic effects with the catalytic reaction analysis dual reactor system. The method can include heating the first and second reactor to substantially the same temperature; feeding the feed gas through the second reactor while feeding the inert gas through the first reactor, wherein a non-catalytic thermal cracking reaction can be conducted in the second reactor while concurrently operating the first reactor at substantially the same conditions as the second reactor; feeding only a gaseous reaction product exiting the second reactor to the gas analyzer and determining a first reference analysis result, then feeding the feed gas through the first reactor while feeding the inert gas through the second reactor, wherein a catalytic thermal cracking reaction can be conducted in the first reactor while concurrently operating the second reactor at substantially the same conditions as the first reactor; feeding only a gaseous reaction product exiting the first reactor to the gas analyzer and determining a second reaction analysis result, and correcting the second reaction analysis result with the first reference analysis result to obtain a corrected reaction analysis result that isolates the effect of the catalyst in the first reactor.

In one embodiment, the feed gas can be a hydrocarbon gas, and the first reference analysis result can be a measurement of thermal hydrocarbon cracking.

In one embodiment, the feed gas can be a hydrocarbon gas, and the second reaction analysis result can be a measurement of the sum of thermal hydrocarbon cracking and catalytic hydrocarbon cracking.

In one embodiment, the gas analyzer can be at least one selected from the group consisting of a gas chromatogram, a mass spectrometer, and an absorption spectrometer.

Referring now to the drawings, wherein like reference numerals designate identical or corresponding parts throughout the several views.

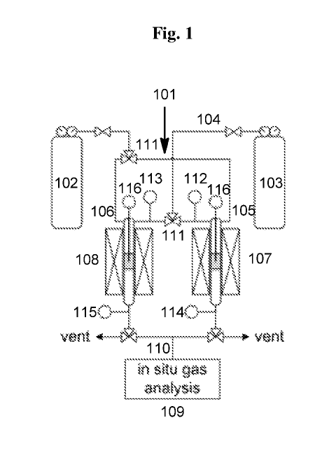

According to a first aspect, the present disclosure relates to a catalytic reaction analysis dual reactor system. As shown in FIG. 1, the dual reactor system includes a gas loop 101 comprising an inert gas source 102, a feed gas source 103, a gas feed line 104, a first reactor feed line 105 and second reactor feed line 106, wherein the inert gas source and the feed gas source are in fluid communication with the gas feed line, and the gas feed line is in fluid communication with the first and second reactor feed lines.

The dual reactor system also consists of two reactors, a first reactor 107 and a second reactor 108. The first reactor 107 includes a first catalyst chamber loaded with a catalyst comprising a first catalyst on a first catalyst support, a first reactor inlet on an upstream side of the first catalyst chamber and a first reactor outlet on a downstream side of the first catalyst chamber. The second reactor 108 includes a second catalyst chamber loaded with a second catalyst support, a second reactor inlet on an upstream side of the second catalyst chamber and a second reactor outlet on a downstream side of the second catalyst chamber, wherein the first and second catalyst chambers are substantially the same and the particle size and amount of the first catalyst and the second catalyst support are substantially the same. In the first reactor, catalysts are loaded for hydrocarbon cracking catalytic experiments, while in the second reactor, only catalytically inert materials (such as non-catalytic aluminum oxides, Al₂O₃) are loaded. This inert material can be the support used for catalyst deposition.

In one embodiment, the dual reactor system optionally comprises a first filter located in the first reactor feed line, upstream of the first reactor, and a second filter located in the second reactor feed line, upstream of the second reactor. The first and second filters, if present, remove solid or liquid particles from the gaseous mixture prior to entering the first or second reactors.

Hydrocarbon cracking is the process whereby organic molecules, such as hydrocarbons, are broken down into simpler molecules, such as light hydrocarbons, by the breaking of carbon-carbon bonds in the hydrocarbon precursors. This process generally forms light olefins (i.e. alkenes) and/or saturated hydrocarbons that have lower molecular weight than the starting material. Light olefins or alkenes include any unsaturated open-chain hydrocarbons, such as ethylene, propylene, butylene, etc. Hydrocarbon cracking can also involve the dehydrogenation of saturated alkanes to form corresponding alkenes. In addition to simple hydrocarbons, ethane, propane, butane, etc., or C₂, C₃, C₄, C₅, C₆, C₇, C₈, etc. containing compounds, higher molecular weight hydrocarbon feedstocks, e.g., naphtha, high boiling or heavy fractions of petroleum, petroleum residuum, shale oil, tar sand oil, coal and the like, may also be cracked to form light hydrocarbons.

In terms of the present invention, the term hydrocarbon cracking may refer to the process of breaking carbon-carbon bonds and/or the dehydrogenation of a saturated alkane to a corresponding alkene.

Thermal cracking is a process in which hydrocarbons such as crude oil are subjected to high temperature to break the molecular bonds and reduce the molecular weight of the substance being cracked.

Steam cracking is a petrochemical process in which saturated hydrocarbons are broken down into smaller, often unsaturated, hydrocarbons. It is the principal industrial method for producing the light olefins, including ethylene and propylene. Steam cracker units are facilities in which a feedstock such as naphtha, liquefied petroleum gas (LPG), ethane, propane or butane is thermally cracked through the use of steam in a bank of pyrolysis furnaces to produce lighter hydrocarbons. The products obtained depend on the composition of the feed, the hydrocarbon-to-steam ratio, and on the cracking temperature and furnace residence time.

The catalytic cracking process typically involves an acid catalyst, usually solid acids such as zeolites, which promote a heterolytic cleavage of bonds. This process generates carbon-localized free radicals and cations, both of which are highly unstable and undergo processes of chain rearrangement, C-C scissions, and intra- and intermolecular hydrogen transfer.

Hydrocracking is a catalytic cracking process assisted by the presence of added hydrogen gas, which is used to break C-C bonds.

In regards to the present disclosure, the hydrogen cracking system can utilize several cracking methodologies, including, but not limited to thermal cracking, steam cracking, fluid catalytic cracking, and hydrocracking.

In one embodiment, the feed gas is a hydrocarbon gas, and the catalytic reaction is a hydrocarbon cracking reaction.

In one embodiment, the feed gas is a hydrocarbon gas, and the catalytic reaction is a hydrocarbon dehydrogenation reaction.

In the present invention, thermal hydrocarbon cracking refers to any cracking process that takes place due to high temperatures, whereby the conversion of starting material and the product selectivity is temperature dependent. This temperature-dependent thermal cracking process may also be referred to as “non-catalytic”. Catalytic hydrocarbon cracking of the present invention refers to any cracking process that takes place due to the presence of a catalyst. Catalytic hydrocarbon cracking is often performed at elevated temperatures. Therefore, products from a catalytic hydrocarbon cracking process may have arisen directly from a catalytic mechanism, or from a catalytic mechanism and a thermal process combined.

In the present invention, the catalyst may include, but is not limited to zeolites, acid treated metal oxides (e.g. acid treated alumina), or acid treated clays. Zeolites are microporous, aluminosilicate minerals. Some of the more common mineral zeolites are analcime, chabazite, clinoptilolite, heulandite, natrolite, phillipsite, and stilbite. Synthetic catalysts may include composites of silica and alumina or other metal oxides, including silica-alumina, silica-magnesia, silica-zirconia, silica-thoria, silica-beryllia, silica-titania, silicavanadia, as well as ternary combinations such as silica-alumina-magnesia, silica-alumina-zirconia, and silica-magnesia-zirconia. Other bifunctional catalysts include, platinum and/or rhodium doped zeolites, and platinum-alumina. Acid treated natural clays which may be suitable for use as the catalyst in the invention include kaolins, sub-bentonites, montmorillonite, fullers earth, and halloysite.

For purposes of the present invention the catalyst support refers to a high surface area material to which a catalyst is affixed. The support can be inert or can participate in catalytic reactions. The reactivity of heterogeneous catalysts and nanomaterial-based catalysts occurs at the surface atoms. Consequently great effort is made to maximize the surface area of a catalyst by distributing it over the support. Typical supports include various kinds of carbon, alumina, and silica. In one embodiment, the catalyst support is aluminum oxide. The catalyst support may be comprised of a plurality of different crystallographic phases. Therefore, in terms of alumina, the catalyst support may comprise α-Al₂O₃, γ-Al₂O₃, or a mixture thereof.

In the present invention, the contents of the first and second reactor are the same, with the exception of the presence of a catalyst in the first reactor. The loaded contents in the reactors have the sample particle sizes and weights to keep their GHSV (gas hourly space velocity).

In one embodiment, the reactors of the present invention may be made of a silicon-oxygen framework (e.g. quartz) or a metal alloy (e.g. Inconel).

In chemical processing, a fixed bed reactor is a hollow tube, pipe, or other vessel that is filled with catalyst particles or adsorbents such as zeolite pellets, granular activated carbon, etc. The purpose of a fixed bed is typically to improve contact between two phases in a chemical or similar process. In a chemical reactor, a fixed bed is most often used to catalyze gas reactions and the reaction takes place on the surface of the catalyst. The advantage of using a fixed bed reactor is the higher conversion per weight of catalyst than other catalytic reactors. The conversion is based on the amount of the solid catalyst rather than the volume of the reactor. In one embodiment, the first and the second reactors are fixed-bed reactors.

In chemical engineering and reactor engineering, space velocity refers to the quotient of the entering volumetric flow rate of the reactants divided by the reactor volume (or the catalyst bed volume) which indicates how many reactor volumes of feed can be treated in a unit time. It is commonly regarded as the reciprocal of the reactor space time. In industry, space velocity can be further defined by the phase of the reactants at given conditions. Special values for this measurement exist for liquids and gases, and for systems that use solid catalysts. Gas hourly space velocity (GHSV) is a method for relating a gaseous reactant flow rate to the reactor volume. In addition to other parameters, the particle size of the catalyst and/or catalyst support in the reactor affects the GHSV. Therefore, in the present invention, the particle size is held constant between the first and second reactor to maintain a uniform GHSV.

In one embodiment, the inert gas may be any gas that does not readily undergo chemical reactions. The inert gas source may be, but is not limited to, atomic nitrogen, helium, neon, argon, krypton, xenon, radon, or mixtures thereof.

The dual reactor system also contains a gas analyzer 109 comprising an analysis feed line 110 downstream of and connected to the first and second reactor outlets, wherein the first and second reactor are connected in parallel to the gas feed line and the analysis feed line.

In one embodiment, the gas analyzer is at least one selected from the group consisting of a gas chromatogram, a mass spectrometer, and an absorption spectrometer.

In one embodiment, the gas analyzer is a gas chromatogram. A gas chromatogram (GC) is an apparatus which feeds a gas sample into a column via a carrier gas, separates the respective components in the gas sample over time inside the column, and detects the components with a detector provided at the column outlet. In a typical instrument, the carrier gas is continuously passed through the chamber or column which is packed with a granular material having particular adsorption characteristics or which is coated with a liquid having particular gas or vapor solubility characteristics. Since the rates at which the respective components move into the column differ depending on the strengths of the interactions between the respective components in the sample and a stationary phase inside the column, the respective components are separated over time. At this time, the flow rate of the carrier gas is set to a rate within an optimal flow rate range at which the components in the sample can be sufficiently separated and at which peaks with sharp shapes can be obtained. In one embodiment, the GC column is a capillary column or a packed column. Helium, hydrogen, or nitrogen gas may be used as a carrier gas depending on what gaseous components require detection. The rates at which the carrier gas or the respective components in the sample move into the column change due to the temperature or the like inside the column. Therefore, analysis cannot be performed accurately until these are stabilized. However, a long amount of time is required from when the power of the apparatus is turned on until the temperature or the like inside the column is stabilized at a prescribed value. Therefore, even if there is a certain amount of time after a given analysis is completed until the next analysis is performed, it is typical to maintain a standby state in which the temperature or the like inside the column is stabilized at a prescribed value in the same manner as at the time of analysis while the power is kept on. The carrier gas is circulated into the column even in the standby state. This is to prevent the stationary phase inside the column from degenerating due to water content or oxygen infiltrating from the outside or, conversely, to prevent the stationary phase from flowing out from the column outlet. In one embodiment, the gas chromatogram has a column which separates respective components contained in a gas sample introduced via a carrier gas over time, wherein an analysis mode in which an analysis of said gas sample is executed and a standby mode in which an analysis is not executed can be switched and executed. In one embodiment, the GC has a plurality of chromatographic columns operated in parallel. In an alternative embodiment, the plurality of columns may be operated such that a first column is operated in analysis mode, while a second column is in standby mode.

In one embodiment, the dual reactor system optionally comprises a third filter located in the analysis feed line, upstream of the gas analyzer. The second filter, if present, removes solid or liquid particles from the gaseous mixture prior to entering the gas analyzer.

In one embodiment, the gas loop comprises two three way valves 111 positioned in the gas feed line between the first reactor feed line and the second reactor feed line, wherein the feed gas and the inert gas source are shared and the three way valves may be adjusted so that i) the feed gas is passed through the second reactor while the inert gas is passed through the first reactor, or ii) the feed gas is passed through the first reactor while the inert gas is passed through the second reactor.

In one embodiment, no four, five, or six-way valves are present in the gas loop.

In one embodiment, catalytic reaction analysis dual reactor system further comprises a first inlet pressure sensor 112 located upstream of and connected to the gas feed line of the first reactor and a second inlet pressure sensor 113 located upstream of and connected to the gas feed line of the second reactor, and a first outlet pressure sensor 114 located downstream of and connected to the first reactor outlet and a second outlet pressure sensor 115 located downstream of and connected to the second reactor outlet. In one embodiment, the first and second inlet pressure sensors measure the pressure of gas entering the first and second reactors, and the first and second outlet pressure sensors measure the pressure of gas exiting the first and second reactors in parallel. FIG. 1 illustrates that in addition to the pressure, the temperature in the first and second reactors are also monitored with temperature sensors 116.

In one embodiment, the catalytic reaction analysis dual reactor system further comprises a tube furnace, and a PC control unit, wherein the PC control unit controls the temperature of the tube furnace and the tube furnace controls the temperature of the first and second reactor, and the temperature of the first and second reactor is the same throughout the catalytic reaction analysis. To keep the same conditions (such as flow rate, pressure drop before and after the reactor, temperature), the same tube furnaces are used.

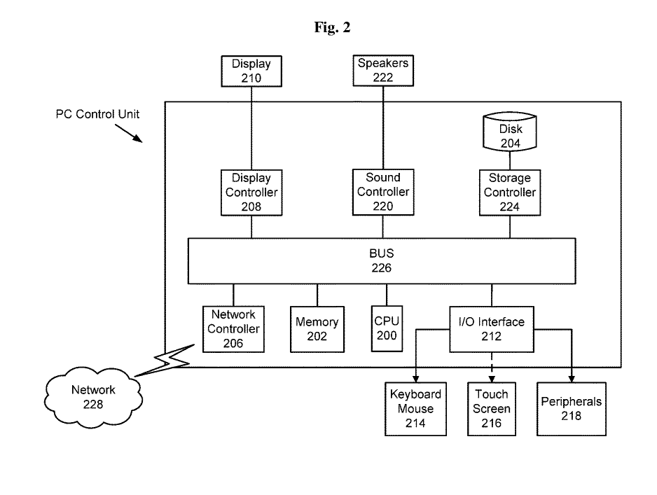

Next, a hardware description of the PC control unit according to exemplary embodiments is described with reference to FIG. 2. In FIG. 2, the PC control unit includes a CPU 200 which performs the processes described above. The process data and instructions may be stored in memory 202. These processes and instructions may also be stored on a storage medium disk 204 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the PC control unit communicates, such as a server or computer.

Further, the claimed advancements may be provided as a utility application, background daemon, or component of an operating system, or combination thereof, executing in conjunction with CPU 200 and an operating system such as Microsoft Windows 7, UNIX, Solaris, LINUX, Apple MAC-OS, including any updates and variants thereof, and other systems known to those skilled in the art.

CPU 200 may be a Xenon or Core processor from Intel of America or an Opteron processor from AMD of America, or may be other processor types that would be recognized by one of ordinary skill in the art. Alternatively, the CPU 200 may be implemented on an FPGA, ASIC, PLD or using discrete logic circuits, as one of ordinary skill in the art would recognize. Further, CPU 200 may be implemented as multiple processors cooperatively working in parallel to perform the instructions of the inventive processes described above.

The PC control unit in FIG. 2 also includes a network controller 206, such as an Intel Ethernet PRO network interface card from Intel Corporation of America, for interfacing with network 228. As can be appreciated, the network 228 can be a public network, such as the Internet, or a private network such as an LAN or WAN network, or any combination thereof and can also include PSTN or ISDN sub-networks. The network 228 can also be wired, such as an Ethernet network, or can be wireless such as a cellular network including EDGE, 3G and 4G wireless cellular systems. The wireless network can also be WiFi, Bluetooth, or any other wireless form of communication that is known.

The PC control unit further includes a display controller 208, such as a NVIDIA GeForce GTX or Quadro graphics adaptor from NVIDIA Corporation of America for interfacing with display 210, such as a Hewlett Packard HPL2445w LCD monitor. A general purpose 110 interface 212 interfaces with a keyboard and/or mouse 214 as well as a touch screen panel 216 on or separate from display 210. General purpose 110 interface also connects to a variety of peripherals 218 including printers and scanners, such as an OfficeJet or DeskJet from Hewlett Packard.

A sound controller 220 is also provided in the PC control unit, such as Sound Blaster X-Fi Titanium from Creative, to interface with speakers/microphone 222 thereby providing sounds and/or music.

The general purpose storage controller 224 connects the storage medium disk 204 with communication bus 226, which may be an ISA, EISA, VESA, PCI, or similar, for interconnecting all of the components of the PC control unit. A description of the general features and functionality of the display 210, keyboard and/or mouse 214, as well as the display controller 208, storage controller 224, network controller 206, sound controller 220, and general purpose 110 interface 212 is omitted herein for brevity as these features are known.

According to a second aspect, the present disclosure relates to a method for measuring the catalytic activity of a catalyst by correcting for non-catalytic effects with the catalytic reaction analysis dual reactor system. The method involves heating the first and second reactor to substantially the same temperature with the same ramp rate using a PC control unit. In on embodiment, the ramp rate is 5-20, preferably 8-17, more preferably 10-15° C./minute. While they are heated, a purging, inert gas (such as argon or nitrogen) is flowed. Once both reactors reach a reaction temperature, the pressure difference and flow rates of the two reactors are carefully measured with inert gas flowing through both reactors. As the temperatures are increased, it is common for the flow rate to slightly decrease. If the flow rate is reduced by more than 5% at a higher temperature compared to that at ambient temperature, some error for the feed amount cannot be avoided.

To obtain background information of “non-catalytic” conditions, the method of the present invention next involves feeding the feed gas through the second reactor while feeding the inert gas through the first reactor, wherein a non-catalytic thermal cracking reaction is conducted in the second reactor while concurrently operating the first reactor at substantially the same conditions as the second reactor. As discussed heretofore, non-catalytic products are those generated without using catalysts, such as the temperature-dependent thermal cracking as described. The background reactivity is critical to differentiate catalytic products from non-catalytic products, particularly for hydrocarbons that undergo facile thermal cracking processes. The method then involves feeding only a gaseous reaction product exiting the second reactor to the gas analyzer and determining a first reference analysis result. This experiment is repeated at least two times, preferably at least three times, more preferably at least four times, even more preferably at least five times to obtain reliable data. In one embodiment, the first reference analysis results are averaged to provide an average reference analysis result.

In one embodiment, the feed gas is a hydrocarbon gas, and the first reference analysis result is a measurement of thermal hydrocarbon cracking.

After the reactors are equilibrated with a stable and accurate feed amount at a desired reaction temperature, a reaction analysis is performed under catalytic conditions. The method includes feeding the feed gas through the first reactor while feeding the inert gas through the second reactor, wherein a catalytic thermal cracking reaction is conducted in the first reactor while concurrently operating the second reactor at substantially the same conditions as the first reactor. The method then involves feeding only a gaseous reaction product exiting the first reactor to the gas analyzer and determining a second reaction analysis result. This experiment is repeated at least two times, preferably at least three times, more preferably at least four times, even more preferably at least five times to obtain reliable data. In one embodiment, the second reaction analysis results are averaged to provide an average reaction analysis result.

In one embodiment, the feed gas is a hydrocarbon gas, and the second reaction analysis result is a measurement of the sum of thermal hydrocarbon cracking and catalytic hydrocarbon cracking.

Lastly, the method comprises correcting the second reaction analysis result with the first reference analysis result to obtain a corrected reaction analysis result that isolates the effect of the catalyst in the first reactor. In one embodiment, the average corrected reaction analysis result is obtained by correcting the average second reaction analysis result with the average first reference analysis result.

The systems and methods disclosed herein include(s) at least the following embodiments:

### Embodiment 1

A catalytic reaction analysis dual reactor system, comprising: a gas loop comprising an inert gas source, a feed gas source, a gas feed line, a first reactor feed line and second reactor feed line, wherein the inert gas source and the feed gas source are in fluid communication with the gas feed line and the gas feed line is in fluid communication with the first and second reactor feed lines; a first reactor comprising a first catalyst chamber loaded with a catalyst comprising a first catalyst on a first catalyst support, a first reactor inlet on an upstream side of the first catalyst chamber and a first reactor outlet on a downstream side of the first catalyst chamber; a second reactor comprising a second catalyst chamber loaded with a second catalyst support, a second reactor inlet on an upstream side of the second catalyst chamber and a second reactor outlet on a downstream side of the second catalyst chamber; wherein the first and second catalyst chambers are substantially the same and the particle size and amount of the first catalyst and the second catalyst support are substantially the same; a gas analyzer comprising an analysis feed line downstream of and connected to the first and second reactor outlets; wherein the first and second reactor are connected in parallel to the gas feed line and the analysis feed line.

### Embodiment 2

The catalytic reaction analysis dual reactor system of Embodiment 1, wherein the gas loop comprises two three way valves positioned in the gas feed line between the first reactor feed line and the second reactor feed line.

### Embodiment 3

The catalytic reaction analysis dual reactor system of Embodiment 1 or Embodiment 2, wherein the feed gas and the inert gas source are shared and the three way valves are adjusted so that the feed gas is passed through the second reactor while the inert gas is passed through the first reactor, or the feed gas is passed through the first reactor while the inert gas is passed through the second reactor.

### Embodiment 4

The catalytic reaction analysis dual reactor system of any of the preceding embodiments, further comprising: a first inlet pressure sensor located upstream of and connected to the gas feed line of the first reactor and a second inlet pressure sensor located upstream of and connected to the gas feed line of the second reactor; and a first outlet pressure sensor located downstream of and connected to the first reactor outlet and a second outlet pressure sensor located downstream of and connected to the second reactor outlet; wherein the first and second inlet pressure sensors measure the pressure of gas entering the first and second reactors, and the first and second outlet pressure sensors measure the pressure of gas exiting the first and second reactors in parallel.

### Embodiment 5

The catalytic reaction analysis dual reactor system of any of the preceding embodiments, further comprising: a tube furnace; and a PC control unit; wherein the PC control unit controls the temperature of the tube furnace and the tube furnace controls the temperature of the first and second reactor.

### Embodiment 6

The catalytic reaction and analysis dual reactor system of Embodiment 5, wherein the temperature of the first and second reactor is the same throughout the catalytic reaction analysis.

### Embodiment 7

The catalytic reaction analysis dual reactor system of any of the preceding embodiments, wherein the feed gas is a hydrocarbon gas, and the catalytic reaction is a hydrocarbon cracking reaction.

### Embodiment 8

The catalytic reaction analysis dual reactor system of any of the preceding embodiments, wherein the feed gas is a hydrocarbon gas, and the catalytic reaction is a hydrocarbon dehydrogenation reaction.

### Embodiment 9

The catalytic reaction analysis dual reactor system of any of the preceding embodiments, wherein the first and the second reactors are fixed-bed reactors.

### Embodiment 10

A method for measuring the catalytic activity of a catalyst by correcting for non-catalytic effects with the catalytic reaction analysis dual reactor system of any of the preceding embodiments, comprising: heating the first and second reactor to substantially the same temperature; feeding the feed gas through the second reactor while feeding the inert gas through the first reactor, wherein a non-catalytic thermal cracking reaction is conducted in the second reactor while concurrently operating the first reactor at substantially the same conditions as the second reactor; feeding only a gaseous reaction product exiting the second reactor to the gas analyzer and determining a first reference analysis result; feeding the feed gas through the first reactor while feeding the inert gas through the second reactor, wherein a catalytic thermal cracking reaction is conducted in the first reactor while concurrently operating the second reactor at substantially the same conditions as the first reactor; feeding only a gaseous reaction product exiting the first reactor to the gas analyzer and determining a second reaction analysis result; and correcting the second reaction analysis result with the first reference analysis result to obtain a corrected reaction analysis result that isolates the effect of the catalyst in the first reactor.

### Embodiment 11

The method of Embodiment 10, wherein the feed gas is a hydrocarbon gas.

### Embodiment 12

The method of Embodiment 10 or Embodiment 11, wherein the first reference analysis result is a measurement of thermal hydrocarbon cracking.

### Embodiment 13

The method of any of Embodiments 10-12, wherein the feed gas is a hydrocarbon gas.

### Embodiment 14

The method of any of Embodiments 10-13, wherein the second reaction analysis result is a measurement of the sum of thermal hydrocarbon cracking and catalytic hydrocarbon cracking.

### Embodiment 15

The method of any of Embodiments 10-14, wherein the gas analyzer is at least one selected from the group consisting of a gas chromatogram, a mass spectrometer, and an absorption spectrometer.

In general, the invention may alternately comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention. The endpoints of all ranges directed to the same component or property are inclusive and independently combinable (e.g., ranges of “less than or equal to 25 wt %, or 5 wt % to 20 wt %,” is inclusive of the endpoints and all intermediate values of the ranges of “5 wt % to 25 wt %,” etc.). Disclosure of a narrower range or more specific group in addition to a broader range is not a disclaimer of the broader range or larger group. “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. “Or” means “and/or.” The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

The modifier “about” used in connection with a quantity is inclusive of the stated value and has the meaning dictated by the context (e.g., includes the degree of error associated with measurement of the particular quantity). The notation “±10%” means that the indicated measurement can be from an amount that is minus 10% to an amount that is plus 10% of the stated value. The terms “front”, “back”, “bottom”, and/or “top” are used herein, unless otherwise noted, merely for convenience of description, and are not limited to any one position or spatial orientation. “Optional” or “optionally” means that the subsequently described event or circumstance can or cannot occur, and that the description includes instances where the event occurs and instances where it does not. Unless defined otherwise, technical and scientific terms used herein have the same meaning as is commonly understood by one of skill in the art to which this invention belongs. A “combination” is inclusive of blends, mixtures, alloys, reaction products, and the like.

Unless otherwise specified herein, any reference to standards, regulations, testing methods and the like, such as ASTM D1003, ASTM D4935, ASTM 1746, FCC part 18, CISPR11, and CISPR 19 refer to the standard, regulation, guidance or method that is in force at the time of filing of the present application.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A catalytic reaction analysis dual reactor system, comprising:
a gas loop comprising an inert gas source, a feed gas source, a gas feed line, a first reactor feed line and second reactor feed line, wherein the inert gas source and the feed gas source are in fluid communication with the gas feed line and the gas feed line is in fluid communication with the first and second reactor feed lines;
a first reactor comprising a first catalyst chamber loaded with a catalyst comprising a first catalyst on a first catalyst support, a first reactor inlet on an upstream side of the first catalyst chamber and a first reactor outlet on a downstream side of the first catalyst chamber;
a second reactor comprising a second catalyst chamber loaded with a second catalyst support, a second reactor inlet on an upstream side of the second catalyst chamber and a second reactor outlet on a downstream side of the second catalyst chamber;
wherein the first and second catalyst chambers are substantially the same and the particle size and amount of the first catalyst and the second catalyst support are substantially the same;
a gas analyzer comprising an analysis feed line downstream of and connected to the first and second reactor outlets;
wherein the first and second reactor are connected in parallel to the gas feed line and the analysis feed line.

2. The catalytic reaction analysis dual reactor system of claim 1, wherein the gas loop comprises two three way valves positioned in the gas feed line between the first reactor feed line and the second reactor feed line.

3. The catalytic reaction analysis dual reactor system of claim 1, wherein the feed gas and the inert gas source are shared and the three way valves are adjusted so that the feed gas is passed through the second reactor while the inert gas is passed through the first reactor, or the feed gas is passed through the first reactor while the inert gas is passed through the second reactor.

4. The catalytic reaction analysis dual reactor system of claim 1, further comprising:
a first inlet pressure sensor located upstream of and connected to the gas feed line of the first reactor and a second inlet pressure sensor located upstream of and connected to the gas feed line of the second reactor; and
a first outlet pressure sensor located downstream of and connected to the first reactor outlet and a second outlet pressure sensor located downstream of and connected to the second reactor outlet;
wherein the first and second inlet pressure sensors measure the pressure of gas entering the first and second reactors, and the first and second outlet pressure sensors measure the pressure of gas exiting the first and second reactors in parallel.

5. The catalytic reaction analysis dual reactor system of claim 1, further comprising:
a tube furnace; and
a PC control unit;
wherein the PC control unit controls the temperature of the tube furnace and the tube furnace controls the temperature of the first and second reactor.

6. The catalytic reaction and analysis dual reactor system of claim 5, wherein the temperature of the first and second reactor is the same throughout the catalytic reaction analysis.

7. The catalytic reaction analysis dual reactor system of claim 1, wherein the feed gas is a hydrocarbon gas, and the catalytic reaction is a hydrocarbon cracking reaction.

8. The catalytic reaction analysis dual reactor system of claim 1, wherein the feed gas is a hydrocarbon gas, and the catalytic reaction is a hydrocarbon dehydrogenation reaction.

9. The catalytic reaction analysis dual reactor system of claim 1, wherein the first and the second reactors are fixed-bed reactors.

10. A method for measuring the catalytic activity of a catalyst by correcting for non-catalytic effects with the catalytic reaction analysis dual reactor system of claim 1, comprising:
heating the first and second reactor to substantially the same temperature;
feeding the feed gas through the second reactor while feeding the inert gas through the first reactor, wherein a non-catalytic thermal cracking reaction is conducted in the second reactor while concurrently operating the first reactor at substantially the same conditions as the second reactor;
feeding only a gaseous reaction product exiting the second reactor to the gas analyzer and determining a first reference analysis result;
feeding the feed gas through the first reactor while feeding the inert gas through the second reactor, wherein a catalytic thermal cracking reaction is conducted in the first reactor while concurrently operating the second reactor at substantially the same conditions as the first reactor;
feeding only a gaseous reaction product exiting the first reactor to the gas analyzer and determining a second reaction analysis result; and
correcting the second reaction analysis result with the first reference analysis result to obtain a corrected reaction analysis result that isolates the effect of the catalyst in the first reactor.

11. The method of claim 10, wherein the feed gas is a hydrocarbon gas.

12. The method of claim 10, wherein the first reference analysis result is a measurement of thermal hydrocarbon cracking.

13. The method of claim 10, wherein the feed gas is a hydrocarbon gas.

14. The method of claim 10, wherein the second reaction analysis result is a measurement of the sum of thermal hydrocarbon cracking and catalytic hydrocarbon cracking.

15. The method of claim 10, wherein the gas analyzer is at least one selected from the group consisting of a gas chromatogram, a mass spectrometer, and an absorption spectrometer.
